(19) United States
(12) Patent Application Publication
(10) Pub. No.: US 2001/0013354 A1
(43) Pub. Date: Aug. 16, 2001

(54) Dental floss

(76) Inventors: Emilson Ismael Netto, Jacarei (BR); Luiz Bellino Simionato, Sao Jose dos Campos (BR); Joseph David Melnik, Sao Paulo (BR)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/838,804

(22) Filed: Apr. 20, 2001

Related U.S. Application Data
(63) Continuation of application No. 09/554,012, filed on Aug. 16, 2000.
Application No. 09/554,012 is a 371 of international application No. PCT/BR98/00106, filed on Nov. 13, 1998.

(30) Foreign Application Priority Data
Nov. 17, 1997 (BR) PI 9705386-4

(51) Int. Cl. A61C 15/00

(52) U.S. Cl. 132/321

(57) ABSTRACT

Dental floss, of the type comprising a strand consisting of multiple filaments, which are made from one or more materials selected from the group consisting of cotton, silk and polymeric materials, and a coating composition which impregnates said strand and includes a water emulsionable carrier carrying one or more active agents selected from the group consisting of germicides, therapeutic agents, flavorants, sweeteners, abrasives and others, at least one sweetener being in aqueous solution. According to the invention, the water emulsionable carrier includes a waxy material selected from the group consisting of animal waxes, mineral waxes, vegetable waxes, synthetic waxes and mixtures of two or more of these waxes and an emulsifier, in order to make said coating composition homogeneous and soluble in saliva, the sweetener aqueous solution having a sufficiently low amount of water to prevent the impregnated strand from exuding when compressed.

### FIELD OF THE INVENTION

The present invention refers to a dental floss and, more particularly, to strands and tapes for interdental cleaning, having improved characteristics of lubricity and of power for removing food remnants which are entrapped in the interproximal dental regions.

### BACKGROUND OF THE INVENTION

A well known embodiment for dental strands and tapes (for simplification hereinafter named dental flosses) consists of a braid of filaments from cotton, silk or several polymeric materials, which is impregnated in a heated bath with an additive composition containing a wax as a carrier, and one or more additives among germicides, therapeutic agents, flavorants, sweeteners and abrasives, among others. The cooled additive composition forms a coating on the dental floss in which, besides aggregating the several additives, the wax has the functions of aggregating the braided filaments and of acting as a lubrifying agent, facilitating the introduction of the strand in the interproximal dental regions, as well as its sliding during application.

However, in spite of their good lubricity characteristics, due to the braided, thus cohesive disposition of their filaments, these dental flosses are not provided with anchor points which allow the holding and consequent removal of food particles with its use. Such filamentary compaction, since it allows only the superficial incorporation of the coating, it also limits this type of dental floss because of the small antiseptic and therapeutic load it may incorporate.

To overcome these limitations, the so-called texturized dental flosses have been developed, in which filaments are unbraided and then impregnated with the additive composition. Besides having a greater contact surface with the interproximal dental surfaces, as well as a good capability for removing food particles which are entrapped in the interstices of the loose filaments, the texturized dental flosses have the additional advantage of incorporating substantially larger amounts of additive composition in the interfilamentary spaces, providing a final product with greater antiseptic and therapeutic power. However, it has been observed that a wax-based additive composition, such as that described above, when applied to a texturized dental floss, upon the winding thereof at the feeding means of the dental floss packaging station, suffers an exudation which makes the strand surface sticky, impairing the next packaging step and also making the strand unpleasant to be handled by the user. It has been noted that this problem is due to the fact that the wax stiffens externally, preventing the drying of the interfilamentary portion of the coating, the remaining humidity being “squeezed out” of the strand due to the winding tension of the strand at the feeding means.

In order to overcome this problem, there were developed texturized strands, in which the wax, as a carrier, was eliminated. An example of this solution is the dental floss object of patent U.S. Pat. No. 5,098,711, assigned to Hill et al. at Mar. 24, 1992, which mentions in its additive composition just a small amount of polyethylene wax, the function of which is to deposit in the interproximal dental regions during the application of the strand, forming a protective coating during a period of time after the cleaning.

This texturized strand, on the other hand, due to the lack of lubrication provided by the wax becomes rough in use, besides transmitting to the user the sensation that it is fraying. Due to these unpleasant sensations, a part of the consumer market rejects this type of dental floss.

### DISCLOSURE OF THE INVENTION

It is therefore an object of the present invention to provide a texturized dental floss, which combines the characteristics of high power for removing food remnants entrapped in the interproximal dental regions with a high lubricity, allowing the user to have an efficient and pleasant application.

It is also an object of the present invention to provide a dental floss as described above, that although coated with a wax based additive composition, is of easy manufacturing and packaging, without presenting exudations derived from the humidity retained in the coating, upon drying.

It is still an object of the present invention to provide a dental floss as described above, which has a substantially enlarged antiseptic and/or therapeutic load.

It is a further object of the present invention to provide a dental floss as described above, which provides a controlled release of the antiseptic and/or therapeutic load of its coating.

These and other objectives and advantages of the present invention are achieved through the provision of a dental floss for the hygiene and/or interdental therapy of the type comprising a strand composed of multiple filaments, which are made from one or more materials selected from the group consisting of cotton, silk and polymeric materials; and a coating composition, impregnating said strand and comprising a water emulsionable carrier, carrying one or more active agents selected from the group consisting of germicides, therapeutic agents, flavorants, sweeteners, abrasives and others, at least one sweetener being in aqueous solution.

According to the invention, the water emulsionable carrier comprises a waxy material selected from the group consisting of animal waxes, mineral waxes, vegetable waxes, synthetic waxes and mixtures of two or more of these waxes, and one emulsifier, in order to make said coating composition homogeneous and soluble in saliva, the sweetener aqueous solution having a sufficiently low amount of water to avoid the exudation of the impregnated strand.

In practical terms, the dental floss of the invention incorporates the advantages of both the braided and the texturized dental flosses. Since it utilizes wax in its coating composition, the strand of the invention has great lubricity, making pleasant its application by the user and, although being texturized, it has reduced transversal dimensions, due to the aggregation of its filaments by the wax, facilitating the insertion of said dental floss in the interproximal dental regions.

Furthermore, due to the texturized disposition of its filaments, the dental floss of the invention also incorporates the coating composition in its interfilamentary regions, resulting in a substantially increased load of said composition and therefore of the antiseptic and/or therapeutic agents.

Additionally, since the wax is emulsionable in water, the filaments progressively separate from each other and, with the consequent transversal dimensional increase of the strand, the latter will clean more efficiently the interproximal dental surfaces, as well as remove the food remnants which are entrapped within the filaments. Furthermore, the coating composition of said dental floss releases its load of active substances as the wax is progressively, thus controllably, dissolved in the saliva, extending the effect of its antiseptic and/or theraupetic load, as well as the pleasant flavor provided by the flavoring and sweetening agents.

Finally, the dental floss of the invention presents an extremely soft texture.

### DETAILED DESCRIPTION OF THE PREFERRED EMBODIMENT

The present invention refers to a dental floss, which is to be used for hygiene and/or interdental therapy and which is composed of multiple filaments, which are made from one or more materials selected among cotton, silk, nylon, PTFE and other polymeric materials.

According to the invention, said filaments are opened through a texturizing treatment, preferably by heat, of a filamentar braid, or basic strand, which is commercially available, being obtained a texturized strand which is next impregnated, by passing through a heated bath, with a coating composition, resulting in the coated dental floss which is wound in a feeding means, wherefrom it is discharged for packaging.

The coating composition of the dental floss comprises an emulsion of a water emulsionable carrier, carrying one or more active agents selected among germicides, therapeutic agents, flavorants, sweeteners, abrasives and others, such as antioxidants. The water emulsionable carrier includes a waxy material selected from the group consisting of animal waxes, mineral waxes, vegetable waxes, synthetic waxes and mixtures of two or more thereof; and an emulsifier selected among glyceryl monoestearate, ethoxilated glyceryl monoestearate, sorbitane monoestearate and mixtures thereof.

In the preferred embodiment of the invention, the water emulsionable carrier includes: 4 to 10% by weight, based on the total weight of the coating composition, of a mineral wax, such as a microcrystalline wax, and from 25 to 40% by weight, based on the total weight of the coating composition, of a refined bee wax; and the emulsifier includes from 3 to 10% by weight, based on the total weight of the coating composition, of glyceryl monoestearate, 22 to 30% by weight, based on the total weight of the coating composition, of ethoxilated glyceryl monoestearate, and from 23 to 35% by weight, based on the total weight of the coating composition, of sorbitane monoestearate.

In the composition of the water emulsionable carrier, the mixture of the microcrystalline and bee waxes has the primary functions of lubricating the strand, aggregating its filaments and carrying the active agents, as described below. Furthermore, the microcrystalline and bee waxes have the secundary functions of bodyfying the coating and providing the characteristic of softness in the contact point of the dental floss with its application area, respectively. Accordingly, in the case of the emulsifiers, the glyceryl monoestearate and the sorbitane monoestearate share secundary functions of providing consistency and softness to the coating composition.

In a basic composition, designed exclusively to interdental hygiene, one or more flavorants, a sweetener and an abrasive are spread in the water emulsionable carrier as active agents.

In a coating composition, such as that described above, it has been noted that a water content above approximately 4% by weight, based on the total weight of said composition, causes the exudation thereof, this being also promoted by the flavor agent when used as oil.

To overcome the exudation problem, the coating composition utilizes from 10 to 25% by weight, based on its total weight, of one or more flavorants, which are microencapsulated in special arabic gum or modified starch, for example, as commercially available from the flavorant suppliers.

All known sweeteners are solid and water soluble, therefore the water contained in the coating composition originates from the dissolution of the sweetener.

Therefore, in order to reduce the water content of the coating composition of the dental floss of the invention, it is utilized a powerful sweetener, for example those at least 600 times sweeters than sugar, such as sucralose, alitame, etc., and preferably, from about 0.5 to about 3.0% by weight of a 25% sucralose solution, based on the total weight of the composition.

To help in the removal of build-ups, preventing the formation of tartar in the interproximal dental regions, the coating composition of the proposed dental floss further includes a weak abrasive, preferably silica, in an amount from 2 to 15% by weight, based on the total weight of said composition. Besides the abrasive effect, the silica improves the dental floss surface to be held by the user, being also able to absorb any minimal amount of liquid (water and/or oil) that exudes from the strand coating.

The dental floss of the invention is extremely soft and since it has its filaments aggregated by the coating wax, it is initially slim and therefore easy to insert in the interproximal dental regions.

As the dental floss is applied, the coating is progressively released and deposited on the application regions and, simultaneously, the filaments progressively separate and occupy larger spaces of these regions, starting to capture food remnants in the interstices of the filaments and to friction the deposited coating against the interproximal dental regions, removing occasional build-ups and thus avoiding the formation of tartar, etc., by action of silica.

During the whole period of dental floss application, as described above, and during a period after that, said wax is progressively emulsified by the saliva and consequently releases its active composition, providing the user with a lasting and pleasant sensation of cleanness.

As mentioned in the beggining of the description of the invention, the latter was illustrated through the basic embodiment of a dental floss designed only for interdental hygiene. It should be understood, however, that to this basic formulation may be added germicides, pharmaceutical compounds or any desired specific active agents to provide the dental floss with additional antiseptic and/or therapeutic characteristics.

1. Dental floss, of the type comprising a strand consisting of multiple filaments which are made from one or more materials selected from the group consisting of cotton, silk and polymeric materials; and a coating composition, impregnating said strand and comprising a water emulsionable carrier, carrying one or more active agents selected from the group consisting of germicides, therapeutic agents, flavorants, sweeteners, abrasives and others, at least one sweetener being in aqueous solution, characterized in that the water emulsionable carrier comprises a waxy material selected from the group consisting of animal waxes, mineral waxes, vegetable waxes, synthetic waxes and mixtures of two or more of these waxes, and an emulsifyer, in order to make said coating composition homogeneous and soluble in saliva, the sweetener aqueous solution having a sufficiently low amount of water to avoid the exudation of the impregnated strand.

2. Dental floss, according to claim 1, characterized in that the waxy material comprises from 4 to 10% by weight of a microcrystalline wax and from 25 to 40% by weight of a refined bee wax, the emulsifier comprising from 3 to 10% by weight of glyceryl monoestearate, from 22 to 30% by weight of ethoxilated glyceryl monoestearate, and from 23 to 35% by weight of sorbitane monoestearate, based on the total weight of the coating composition.

3. Dental floss, according to claim 1, characterized in that the coating composition further comprises, as a flavorant, from 10 to 25% by weight of at least one microencapsulated flavorant, based on the total weight of said coating composition.

4. Dental floss, according to claim 1, characterized in that the coating composition further comprises, as a sweetening agent, sweeteners which are at least 600 times sweeter than sugar.

5. Dental floss, according to claim 1, characterized in that the coating composition further comprises, as a sweetening agent, from 0.5 to 3% by weight of an aqueous solution at 50% of sucralose.

6. Dental floss, according to claim 1, characterized in that the coating composition further comprises, as an abrasive agent, from 2 to 15% by weight of silica, based on the total weight of said coating composition.

7. Dental floss, according to claim 1, characterized in that the total content of water of said coating composition is no more than 4% by weight of said composition.

8. Dental floss, according to claim 1, characterized in that the strand is texturized by heat.
